(19) United States
(12) Patent Application Publication
(10) Pub. No.: US 2024/0125434 A1
(43) Pub. Date: Apr. 18, 2024

(54) VALVE DEVICE

(71) Applicant: AISAN KOGYO KABUSHIKI KAISHA, Obu-shi (JP)

(72) Inventor: Takafumi URATSUKA, Nagoya-shi (JP)

(21) Appl. No.: 18/376,164

(22) Filed: Oct. 3, 2023

(30) Foreign Application Priority Data
Oct. 12, 2022 (JP) 2022-164175

(51) Int. Cl. F17C 13/04

(52) U.S. Cl. CPC F17C 13/04; F17C 2270/0763

(57) ABSTRACT

A valve device may include a housing, an inlet passage disposed inside the housing and into which a fluid is introduced from outside, a first discharging unit disposed at a downstream end of the inlet passage, an outlet passage disposed inside the housing, communicating with the first discharging unit, and configured to discharge the fluid outside, a communication chamber communicating with the first discharging unit and including an end communicating with the outlet passage, a valve seat disposed on the first discharging unit, and a valve body configured to contact the valve seat and to open and close the first discharging unit. Further, this valve device may comprise a wall body disposed inside the communication chamber, the wall body surrounding the first discharging unit and including an opening defined on an outlet passage side.

### REFERENCE TO RELATED APPLICATION

This application claims priority to Japanese Patent Application No. 2022-164175 filed on Oct. 12, 2022, the contents of which are hereby incorporated by reference into the present application.

### TECHNICAL FIELD

The description herein discloses an art related to valve devices.

### BACKGROUND ART

JP 2013-92224 A (hereinbelow termed Patent Document 1) describes a valve device configured to open and close a fluid channel. The valve device of Patent Document 1 includes an inlet passage into which a fluid is introduced from outside, a first discharging unit disposed at a downstream end of the inlet passage, an outlet passage communicating with the first discharging unit and configured to discharge the fluid outside, a communication chamber communicating with the first discharging unit and including an end communicating with the outlet passage, a valve seat disposed on the first discharging unit, and a valve body configured to contact the valve seat and to open and close the first discharging unit. The fluid introduced from the outside flows through the inlet passage and the first discharging unit and is introduced into the communication chamber, and is discharged outside through the outlet passage.

### DESCRIPTION

### Summary

In the valve device of Patent Document 1, the fluid introduced into the communication chamber moves randomly over the entire communication chamber (by generating turbulence). The fluid that moved close to the outlet passage is discharged outside smoothly by flowing through the outlet passage. However, the fluid that moved to an opposite side from the outlet passage does not have an outlet from the communication chamber (that is, an outlet passage), and further a force to move toward the outlet passage does not act thereon, thus it may stagnate within the communication chamber. When the fluid stagnates within the communication chamber, the fluid could freeze in a low-temperature environment and the valve body could adhere to the valve seat. If the valve body adheres to the valve seat, the valve device can no longer function. The description herein aims to provide a valve device in which such stagnation of a fluid in a communication chamber is suppressed.

A first aspect disclosed herein is a valve device configured to open and close a fluid channel. The valve device may comprise: a housing; a inlet passage disposed inside the housing and into which a fluid is introduced from outside; a first discharging unit disposed at a downstream end of the inlet passage; an outlet passage disposed inside the housing, communicating with the first discharging unit, and configured to discharge the fluid outside; a communication chamber communicating with the first discharging unit and including an end communicating with the outlet passage; a valve seat disposed on the first discharging unit; and a valve body configured to contact the valve seat and to open and close the first discharging unit. Further, this valve device may comprise a wall body disposed inside the communication chamber, the wall body surrounding the first discharging unit and including an opening defined on an outlet passage side.

A second aspect disclosed herein may be the valve device in the first aspect that further comprises a protrusion protruding outward on an opposite side from where the opening of the wall body is defined.

According to the first aspect, the fluid introduced into the communication chamber can be guided to the outlet passage. That is, the fluid introduced in to the communication chamber can be caused to move in one direction (toward the outlet passage). The fluid can be suppressed from stagnating in the communication chamber, and adherence of the valve body and the valve seat caused by the fluid freezing under a low-temperature environment can be suppressed. Further, fluid flow in the communication chamber can be rectified, thus the fluid can be suppressed from contacting a valve seat surface (sealing surface where the valve body makes contact), and the fluid can be suppressed from remaining on the valve seat surface. As a result, the adherence of the valve body and the valve seat caused by the freezing fluid can further be suppressed.

According to the second aspect, the fluid existing outside the wall body can be guided to the outlet passage. Specifically, at a position where the protrusion is disposed (position that is farthest from the outlet passage), a space between the wall body and a sidewall of the communicating passage becomes narrow, by which the fluid moves from the position where the protrusion is disposed toward the outlet passage. As a result, the fluid outside the wall body is guided out from the communication chamber into the outlet passage, and thus stagnation of the fluid inside the communication passage is suppressed. According to the second aspect, the stagnation of the fluid inside the communication chamber can further be suppressed.

### BRIEF DESCRIPTION OF THE DRAWINGS

FIG. 1 shows a schematic view of a fuel cell system including a valve device;

FIG. 2 shows a cross-sectional view of the valve device of a first embodiment;

FIG. 3 shows a perspective view inside a communication chamber; and

FIG. 4 shows a simplified diagram for explaining advantages of the valve device.

### DETAILED DESCRIPTION

(Fuel Cell System Equipped with Valve Device)

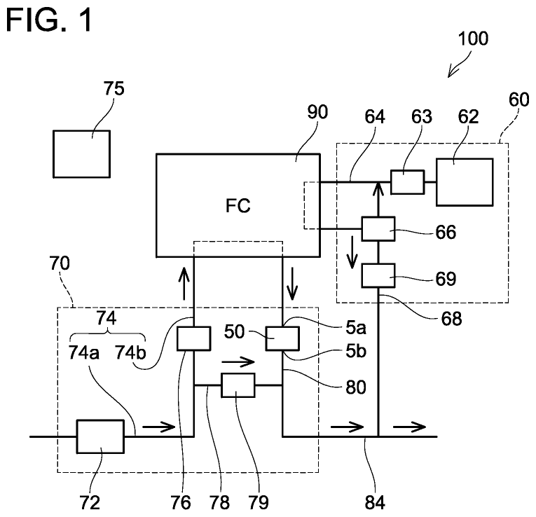

Firstly, a fuel cell system 100 that uses a valve device disclosed herein will be described with reference to FIG. 1. The fuel cell system 100 is suitably mounted on a vehicle (fuel cell vehicle). The fuel cell system 100 comprises a fuel cell stack 90, a hydrogen line 60 for supplying hydrogen gas to the fuel cell stack 90, an air line 70 for supplying air gas (external air) to the fuel cell stack 90, and a controller 75. The fuel cell system 100 is configured to generate electric power by using the hydrogen gas supplied from the hydrogen line 60 and oxygen gas (air gas) supplied from the air line 70.

The hydrogen line 60 comprises a hydrogen gas tank 62, a hydrogen supply passage 64, and a hydrogen discharging passage 68. A pressure reduction valve 63 is disposed on the hydrogen supply passage 64. A pressure of the hydrogen gas supplied from the hydrogen gas tank 62 to the hydrogen supply passage 64 is adjusted by the pressure reduction valve 63. An injector (not shown) is disposed downstream of the pressure reduction valve 63, and the hydrogen gas supplied from the hydrogen gas tank 62 is supplied to the fuel cell stack 90 by the injector. A gas-liquid separator 66 and a hydrogen-discharging valve 69 are disposed on the hydrogen discharging passage 68. The hydrogen-discharging valve 69 is an example of a valve device. The hydrogen-discharging valve 69 is disposed downstream of the gas-liquid separator 66. The hydrogen gas supply to the fuel cell stack 90 is controlled by the controller 75. That is, the controller 75 controls on/off of the hydrogen supply passage 64 and a flow rate of the hydrogen gas flowing through the hydrogen supply passage 64.

Hydrogen gas (hydrogen off gas) discharged from the fuel cell stack 90 is supplied to the gas-liquid separator 66. Hydrogen gas contained in the hydrogen off gas is extracted in the gas-liquid separator 66. The hydrogen gas extracted in the gas-liquid separator 66 is returned to the hydrogen supply passage 64 by a hydrogen circulation pump (not shown) and is supplied to the fuel cell stack 90. On the other hand, remainder of the off gas after having extracted the hydrogen gas in the gas-liquid separator 66 is discharged to the hydrogen discharging passage 68 and is discharged out of the fuel cell system 100 through a discharging pipe 84. The discharging pipe 84 is further connected to an air discharging passage 80 to be described later. A flow rate in the hydrogen discharging passage 68 is adjusted by the hydrogen-discharging valve 69. On/off of the hydrogen discharging passage 68 and a flow rate of the hydrogen off gas flowing through the hydrogen discharging passage 68 are also controlled by the controller 75. The remainder of the off gas after having extracted the hydrogen gas in the gas-liquid separator 66 contains generated water that was generated in the fuel cell system 100.

The air line 70 comprises a compressor 72, an air supply passage 74, an air discharging passage 80, a bypass passage 78, an air supply valve 76, an air-discharging valve 50, and a bypass valve 79. The compressor 72 compresses and feeds external air as the air gas into the air supply passage 74. Further, an air cleaner (not shown) is disposed upstream of the compressor 72. Due to this, clean air gas is supplied to the air supply passage 74. The air supply passage 74 connects the fuel cell stack 90 and the compressor 72. The air supply valve 76 is disposed on the air supply passage 74. Specifically, the air supply passage 74 comprises an upstream air supply passage 74a that connects the compressor 72 and the air supply valve 76 and a downstream air supply passage 74b that connects the air supply valve 76 and the fuel cell stack 90. When the compressor 72 is driven and the air supply valve 76 communicates the upstream air supply passage 74a with the downstream air supply passage 74b, the external air is supplied to the fuel cell stack 90 as the air gas. Here, an intercooler (not shown) is disposed between the compressor 72 and the air supply valve 76. The air gas of which temperature is adjusted (cooled) by the intercooler is supplied to the fuel cell stack 90.

The air discharging passage 80 is connected to the fuel cell stack 90 and discharges air off gas from the fuel cell stack 90. The discharged air off gas is discharged outside the fuel cell system 100 through the discharging pipe 84. The air-discharging valve 50 is disposed on the air discharging passage 80. The air-discharging valve 50 is a butterfly valve, and is controlled by the controller 75. An amount of the air off gas is adjusted by adjusting an opening degree of the air-discharging valve 50. The air off gas contains generated water generated in the fuel cell system 100.

The bypass passage 78 connects the air supply passage 74 and the air discharging passage 80. Specifically, one end of the bypass passage 78 is connected to the upstream air supply passage 74a and the other end thereof is connected to the air discharging passage 80 at a point downstream of the air-discharging valve 50. The bypass valve 79 is disposed on the bypass passage 78, and when the bypass valve 79 opens, the air gas in the air supply passage 74 is supplied to the air discharging passage 80.

(Hydrogen-Discharging Valve)

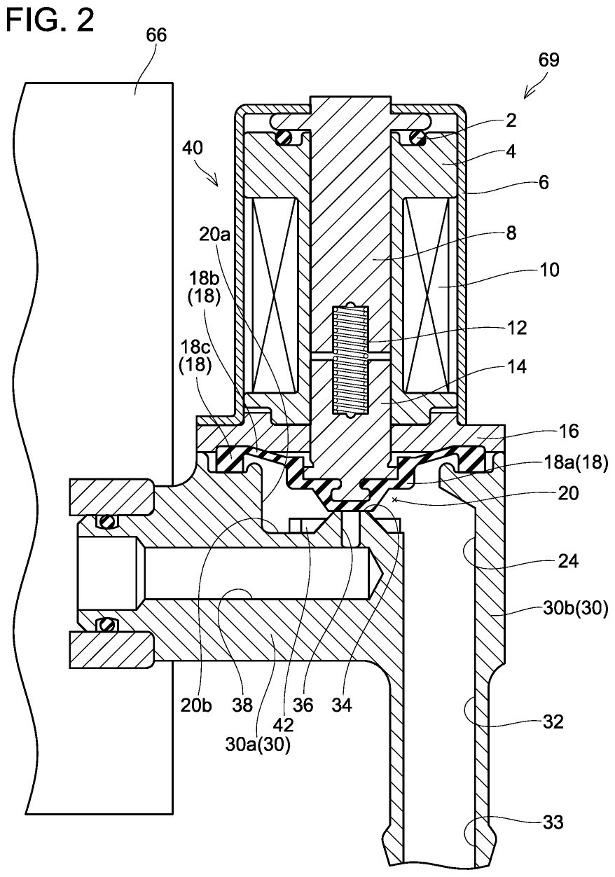

The hydrogen-discharging valve 69 will be described with reference to FIGS. 2 to 4. The hydrogen-discharging valve 69 adjusts the flow rate of the remainder of the off gas after having extracted the hydrogen gas in the gas-liquid separator 66 (generated water). As shown in FIG. 2, the hydrogen-discharging valve 69 comprises a housing 30 through which the generated water flows and a valve unit 40 configured to open and close a channel inside the housing 30. The housing 30 comprises a fluid introducing unit 30a in which an inlet passage 38 is defined and a fluid discharging unit 30b in which an outlet passage 32 is defined. The fluid introducing unit 30a is fixed to the gas-liquid separator 66. A coupling hose (not shown) that constitutes the hydrogen discharging passage 68 is attached to the fluid discharging unit 30b. Further, a communication chamber 20 is disposed between the inlet passage 38 and the outlet passage 32. The generated water introduced into the hydrogen-discharging valve 69 (into the housing 30) from outside the hydrogen-discharging valve 69 (gas-liquid separator 66) flows through the inlet passage 38, the communication chamber 20, and the outlet passage 32 and is discharged out of the hydrogen-discharging valve 69 (hydrogen discharging passage 68).

A first discharging unit 36 is disposed at a downstream end of the inlet passage 38. The first discharging unit 36 is disposed on a sidewall of the inlet passage 38 and opens into the communication chamber 20. The first discharging unit 36 has a shape protruding into the communication chamber 20, and its end surface constitutes a valve seat 34 on which a valve body 18 is to be seated (these elements will be explained later). The first discharging unit 36 has a smaller channel area than the inlet passage 38 and has an orifice shape. A direction along which the first discharging unit 36 extends and a direction along which the inlet passage 38 extends are different. The first discharging unit 36 extends in a direction that substantially intersects orthogonally the direction along which the inlet passage 38 extends. Specifically, the first discharging unit 36 extends in a substantially vertical direction and the inlet passage 38 extends in a substantially horizontal direction. Due to this, the generated water introduced into the inlet passage 38 flows in the inlet passage 38 in the horizontal direction, flows upward inside the first discharging unit 36, and is thereafter discharged into the communication chamber 20. A wall body 42 that surrounds a periphery of the first discharging unit 36 is disposed in the communication chamber 20. The wall body 42 is disposed on a bottom surface 20b of the communication chamber 20 at a position separated away from a sidewall 20a of the communication chamber 20. An internal structure of the communication chamber 20 (details of the wall body 42) will be described later.

An upstream end 24 of the outlet passage 32 communicates with the communication chamber 20. Due to this, the outlet passage 32 communicates with the inlet passage 38 via the communication chamber 20 and the first discharging unit 36. The generated water guided into the outlet passage 32 from the communication chamber 20 flows downward inside the outlet passage 32, and is discharged outside the hydrogen-discharging valve 69 (hydrogen discharging passage 68) from a second discharging unit 33 disposed at a downstream end of the outlet passage 32.

The valve unit 40 is fixed above the housing 30. The valve unit 40 comprises a cylindrical fixation base 4, an electromagnetic coil 10 disposed on an outer circumference of the fixation base 4, an attraction member 8 disposed inside the fixation base 4, a plunger 14 disposed coaxially with the attraction member 8 inside the fixation base 4, a mount plate 16 fixed to the fixation base 4, a valve body 18 fixed to the plunger 14 and the mount plate 16, and a cover 6.

The electromagnetic coil 10 is disposed in a recess defined in an outer circumferential surface of the fixation base 4. A size of an upper end of the attraction member 8 is greater than a cross-sectional size (inner diameter) of the cylindrical fixation base 4. The upper end of the attraction member 8 contacts an upper end surface of the fixation base 4 and separates inside of the cylindrical fixation base 4 from outside. An O-ring 2 is disposed between the upper end of the attraction member 8 and an upper end surface of the fixation base 4, and this O-ring 2 seals the cylindrical fixation base 4. The attraction member 8 is a magnetic body, and a part thereof faces a part of the electromagnetic coil 10.

A coil spring 12 is disposed between the attraction member 8 and the plunger 14. The coil spring 12 is fixed to both the attraction member 8 and the plunger 14 and thereby suppresses these members from coming into contact with each other. The plunger 14 extends through a through hole defined at a center of the mount plate 16. A distal end of the plunger 14 (opposite end from the attraction member 8) has the valve body 18 fixed thereon. Specifically, a center portion 18a of the valve body 18 is fitted in the distal end of the plunger 14, and these members are thereby fixed to each other. Further, an end 18c of the valve body 18 is fixed to the mount plate 16 and a middle portion 18b of the valve body 18 is configured deformable complying to operation of the plunger 14. The operation of the plunger 14 will be described later. Here, the valve body 18 is constituted of rubber and is in a diaphragm shape. The cover 6 is fixed to an upper surface of the mount plate 16 and covers the fixation base 4 and the electromagnetic coil 10, and further isolates the fixation base 4 and the electromagnetic coil 10 from outside.

The mount plate 16 is fixed to an upper surface of the housing 30. When the mount plate 16 is fixed to the housing 30, the valve body 18 comes to face the valve seat 34. More specifically, the center portion 18a of the valve body 18 is pressed onto the valve seat 34 (is seated thereon) by a biasing force (expanding force) of the coil spring 12, by which the first discharging unit 36 is closed. While the valve body 18 (center portion 18a) is seated on the valve seat 34, the inlet passage 38 and the outlet passage 32 do not communicate with each other, thus the generated water is not discharged from the hydrogen-discharging valve 69.

When the electromagnetic coil 10 is electrically conducted, the attraction member 8 is magnetically excited and the plunger 14 is thereby attracted to the attraction member 8. That is, the plunger 14 is attracted toward the attraction member 8 by a magnetic excitation force of the attraction member 8 and moves upward by compressing the coil spring 12. When the plunger 14 moves upward, the center portion 18a of the valve body 18 moves upward together with the plunger 14, and the valve body 18 separates from the valve seat 34. When the valve body 18 separates from the valve seat 34, the inlet passage 38 communicates with the outlet passage 32 and the generated water is discharged from the hydrogen-discharging valve 69.

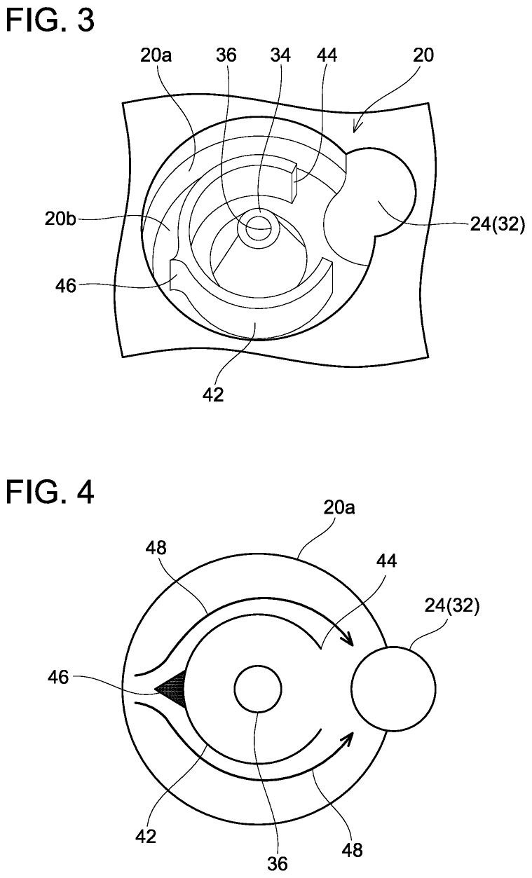

Next, a structure inside the communication chamber 20 will be described with reference to FIG. 3. The first discharging unit 36 communicates with a center portion of the communication chamber 20. The first discharging unit 36 protrudes upward above the communication chamber 20 from the bottom surface 20b of the communication chamber 20. The upstream end 24 of the outlet passage 32 communicates with an end of the communication chamber 20. The communication chamber 20 has an arc shape with the first discharging unit 36 at its center. That is, the sidewall 20a of the communication chamber 20 is circular except for its portion connecting to the upstream end 24 of the outlet passage 32.

The wall body 42 is disposed between the first discharging unit 36 and the sidewall 20a. The wall body 42 surrounds the periphery of the first discharging unit 36 and has an arc shape with the first discharging unit 36 at its center. The wall body 42 does not surround the entire periphery of the first discharging unit 36 and an opening 44 is defined on an outlet passage 32 side (side to which the upstream end 24 is communicated). The shape of the wall body 42 can also be seen as a C-shape. A space is defined between the wall body 42 and the first discharging unit 36 and also between the wall body 42 and the sidewall 20a. The space between the wall body 42 and the first discharging unit 36 is constant along a circumferential direction, and the space between the wall body 42 and the sidewall 20a is also constant along the circumferential direction. A height of the wall body 42 (its protruding height from the bottom surface 20b of the communication chamber 20) is lower than a protruding height of the first discharging unit 36 (see FIG. 2). Due to this, the wall body 42 is suppressed from interfering with (contacting) the valve body 18. Further, a protrusion 46 is disposed on a part of an outer sidewall surface of the wall body 42 (on a sidewall 20a side). The protrusion 46 is substantially triangular, and is disposed on an opposite side from where the opening 44 is defined. That is, the protrusion 46 is disposed at a position of the outer sidewall surface of the wall body 42 that is farthest away from the upstream end 24.

In the hydrogen-discharging valve 69, when the electromagnetic coil 10 is electrically conducted, the valve body 18 separates from the valve seat 34 and the generated water is introduced from the first discharging unit 36 into the communication chamber 20. The generated water introduced into the communication chamber 20 is guided to the outlet passage 32 (upstream end 24) by the wall body 42. In other words, the wall body 42 directs the flow of the generated water in the communication chamber 20 toward the upstream end 24 (rectifies the flow of the generated water) and smoothly guides out the generated water from within the communication chamber 20. That is, the generated water introduced into the communication chamber 20 by the wall body 42 can be suppressed from stagnating inside the communication chamber 20. Further, the wall body 42 suppresses the generated water from generating upward or downward turbulence. By suppressing such upward or downward turbulence of the generated water, the generated water can further be suppressed from adhering to the valve seat 34. The hydrogen-discharging valve 69 achieves an advantage of being able to suppress adherence of the valve body 18 and the valve seat 34 caused by the generated water freezing under a low-temperature environment by suppressing the generated water from stagnating inside the communication chamber 20 and further suppressing the generated water from adhering to the valve seat 34.

Next, other advantages of the hydrogen-discharging valve 69 will be described with reference to FIG. 4. As described above, the protrusion 46 is disposed on the outer sidewall surface of the wall body 42 at the position farthest away from the upstream end 24. The space between the wall body 42 and the sidewall 20a is narrower at the position where the protrusion 46 is disposed than at other positions (where the protrusion 46 is not disposed). Due to this, the generated water at the position where the protrusion 46 is provided moves toward the position(s) where the protrusion 46 is not provided. As a result, the generated water that was on an outer side of the wall body 42 moves in directions separating away from the protrusion 46 as indicated by arrows 48, that is, toward the upstream end 24 of the outlet passage 32. By providing the protrusion 46 on the outer sidewall surface of the wall body 42, the generated water on the outers side of the wall body 42 can be caused to flow toward the upstream end 24 of the outlet passage 32.

### Other Embodiments

In the above embodiment, the fuel cell system 100 provided with the hydrogen-discharging valve 69 and the air-discharging valve 50 has been described. The structure of the hydrogen-discharging valve 69 may be applied to the air-discharging valve 50. That is, a valve device identical to that of the hydrogen-discharging valve 69 may be used as the air-discharging valve 50.

In the above embodiment, a configuration was described in which the first discharging unit communicates with the center portion of the communication chamber and the sidewall of the communication chamber and the wall body each have the arc shape with the first discharging unit at the center thereof. However, the first discharging unit may not necessarily communicate with the center portion of the communication chamber. Further, the sidewall of the communication chamber and/or the wall body may be of shapes other than the arc shape, and may for example have shapes that partially include straight linear shapes. Further, the space between the wall body and the first discharging unit and/or the space between the wall body and the communication chamber each may not be constant in the circumferential direction. For example, the sidewall of the communication chamber may be in the arc shape and the sidewall may be in a U-shape.

Further, the height of the wall body (protruding height from the bottom surface of the communication chamber) may be equal to or greater than the protruding height of the first discharging unit. So long as the wall body is configured not to interfere with the valve body, the height of the wall body may be freely selected. The protrusion provided on the outer sidewall surface of the wall body may be omitted. The essence of the valve device disclosed herein is that it comprises the wall body inside the communication chamber, the wall body surrounding the periphery of the first discharging unit and having the opening defined on the upstream end side of the outlet passage.

Specific examples of the invention disclosed herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. A valve device configured to open and close a fluid channel, the valve device comprising:
a housing;
an inlet passage disposed inside the housing and into which a fluid is introduced from outside;
a first discharging unit disposed at a downstream end of the inlet passage;
an outlet passage disposed inside the housing, communicating with the first discharging unit, and configured to discharge the fluid outside;
a communication chamber communicating with the first discharging unit and including an end communicating with the outlet passage;
a valve seat disposed on the first discharging unit;
a valve body configured to contact the valve seat and to open and close the first discharging unit; and
a wall body disposed inside the communication chamber, the wall body surrounding the first discharging unit and including an opening defined on the outlet passage side.

2. The valve device according to claim 1, further comprising:
a protrusion protruding outward on an opposite side from where the opening of the wall body is defined.
